(19) United States
(12) Patent Application Publication
(10) Pub. No.: US 2025/0172485 A1
(43) Pub. Date: May 29, 2025

(54) IMAGING SYSTEMS AND RELATED SYSTEMS AND METHODS

(71) Applicant: ILLUMINA, INC., San Diego, CA (US)

(72) Inventors: Steven Boege, San Mateo, CA (US); Matthew Hage, San Diego, CA (US); Richard Lemoine, San Diego, CA (US); Peter Newman, San Diego, CA (US)

(21) Appl. No.: 18/725,694

(22) PCT Filed: Dec. 22, 2022
(86) PCT No.: PCT/US2022/053870

§ 371 Date: Jun. 28, 2024

Related U.S. Application Data
(60) Provisional application No. 63/295,005, filed on Dec. 30, 2021.

(51) Int. Cl. G01N 15/1434

(52) U.S. Cl. CPC G01N 15/1436

(57) ABSTRACT

Imaging systems are related systems and methods are disclosed. In accordance with a first implementation, an apparatus includes or comprises a system that includes or comprises a flow cell interface to receive a flow cell cartridge assembly; and an imaging system. The imaging system includes or comprises an imaging device; an optical assembly; a housing carrying the imaging device and the optical assembly; a stage assembly coupled to the housing and comprising an x-stage and a y-stage; and a light source assembly to emit a beam that is received by the optical assembly. The stage assembly moves the housing relative to the flow cell interface to allow the imaging device to obtain image data from the flow cell cartridge assembly.

### RELATED APPLICATION SECTION

This application claims the benefit of and priority to U.S. Provisional Patent Application No. 63/295,005, filed Dec. 30, 2021, the content of which is incorporated by reference herein in its entireties and for all purposes.

### BACKGROUND

Sequencing platforms may include imaging systems. The imaging systems may be used to image samples of interest.

### SUMMARY

Advantages of the prior art can be overcome and benefits as described later in this disclosure can be achieved through the provision of imaging systems and related methods. Various implementations of the apparatus and methods are described below, and the apparatus and methods, including and excluding the additional implementations enumerated below, in any combination (provided these combinations are not inconsistent), may overcome these shortcomings and achieve the benefits described herein.

In accordance with a first implementation, an apparatus, includes or comprises a system that includes or comprises a flow cell interface to receive a flow cell cartridge assembly; and an imaging system. The imaging system includes or comprises an imaging device; an optical assembly; a housing carrying the imaging device and the optical assembly; a stage assembly coupled to the housing and comprising an x-stage and a y-stage; and a light source assembly to emit a beam that is received by the optical assembly. The stage assembly moves the housing relative to the flow cell interface to allow the imaging device to obtain image data from the flow cell cartridge assembly.

In accordance with a second implementation, a method includes or comprises injecting a beam from a light source assembly to an imaging system, the imaging system comprising an imaging device, an optical assembly, a housing carrying the imaging device and the optical assembly, and a stage assembly coupled to the housing; and imaging a flow cell at a flow cell interface by moving the housing using the stage assembly and using the injected beam.

In accordance with a third implementation, an apparatus comprises or includes a system, comprising or including a flow cell interface and an imaging system. The flow cell interface to receive a flow cell cartridge assembly. The imaging system, comprising: an imaging device; an optical assembly; a housing carrying the imaging device and the optical assembly; a stage assembly coupled to the housing; and a light source assembly to emit a beam that is received by the optical assembly. The stage assembly moves the housing relative to the flow cell interface to allow the imaging device to obtain image data from the flow cell cartridge assembly.

In further accordance with the foregoing first, second, and/or third implementations, an apparatus and/or method may further comprise or include any one or more of the following:

In accordance with an implementation, the imaging device is a time delay and integration (TDI) imaging device.

In accordance with another implementation, the imaging system includes or comprises a waveguide coupled to the optical assembly.

In accordance with another implementation, the waveguide includes or comprises an optical fiber coupled to and between the light source assembly and the optical assembly.

In accordance with another implementation, the housing includes or comprises a waveguide port to which the optical fiber is coupled.

In accordance with another implementation, the optical fiber is bendable.

In accordance with another implementation, the light source assembly is coupled to a portion of the system and the stage assembly is movable relative to the light source assembly.

In accordance with another implementation, the portion includes or comprises a frame of the system.

In accordance with another implementation, the housing is coupled to the y-stage.

In accordance with another implementation, the housing includes or comprises an L-shaped housing having or comprising opposing first and second side walls that define an L-shaped channel.

In accordance with another implementation, the optical assembly is disposed within the L-shaped channel and the imaging device is coupled to the first and second side walls.

In accordance with another implementation, the optical assembly includes a lens group and an entry aperture disposed within the L-shaped channel, and the optical assembly is coupled to the imaging device.

In accordance with another implementation, the housing further includes or comprises a waveguide port in the first sidewall or the second sidewall.

In accordance with another implementation, the apparatus further includes or comprises a waveguide. A first end of the waveguide is coupled to the light source assembly and a second end of the waveguide is coupled to the waveguide port.

In accordance with another implementation, the light source assembly is movable relative to the waveguide port and the waveguide is bendable in two directions.

In accordance with another implementation, the light source assembly is coupled to the y-stage.

In accordance with another implementation, the apparatus further includes or comprises a heat sink coupled to the light source assembly.

In accordance with another implementation, the apparatus further includes or comprises a second stage to which the light source assembly is coupled.

In accordance with another implementation, the second stage includes or comprises a follower stage.

In accordance with another implementation, the second stage includes or comprises a one-dimensional movement stage.

In accordance with another implementation, the light source assembly is coupled to the second stage.

In accordance with another implementation, the system causes the second stage to move corresponding to the movement of at least one of the x-stage or the y-stage.

In accordance with another implementation, the second stage includes or comprises at least one of an x-stage or a y-stage.

In accordance with another implementation, the apparatus further includes or comprises a waveguide and an optical receiver to receive the beam. The waveguide is coupled to and between the optical receiver and the optical assembly.

In accordance with another implementation, the optical receiver includes or comprises a fiber coupling lens.

In accordance with another implementation, the apparatus includes or comprises a second stage to which the optical receiver is coupled.

In accordance with another implementation, the optical receiver includes or comprises one or more of: (i) a collimator, (ii) a microlens array, (iii) a diffractive optical element, (iv) a Powell lens, (v) a Lineman lens, (vi) a cylindrical lens, or (vii) an acylindrical lens.

In accordance with another implementation, the system causes the second stage to move the optical receiver relative to the light source assembly.

In accordance with another implementation, the apparatus includes or comprises a laser speckle reducer disposed perpendicular to the beam.

In accordance with another implementation, the apparatus includes or comprises a laser speckle reducer coupled adjacent to the light source assembly.

In accordance with another implementation, the apparatus includes or comprises a laser speckle reducer coupled to the second stage adjacent to the optical receiver.

In accordance with another implementation, the optical receiver is coupled to the y-stage.

In accordance with another implementation, the apparatus includes or comprises a first directional optical element and a second directional optical element.

In accordance with another implementation, the apparatus includes or comprises a second stage and the first directional optical element is coupled to the second stage and the second directional optical element is coupled to the y-stage.

In accordance with another implementation, the light source assembly directs the beam to the first directional optical element, the first directional optical element redirects the beam to the second directional optical element, and the second directional optical element redirects the beam to the optical receiver.

In accordance with another implementation, at least one of the first directional optical element or the second directional optical element includes a low-displacement actuator.

In accordance with another implementation, the first directional optical element is coupled to the second stage and the second directional optical element is coupled to the housing.

In accordance with another implementation, the light source assembly is a laser diode illuminator (LDI).

In accordance with another implementation, the imaging includes or comprises producing a time delay and integration (TDI) image of the flow cell.

In accordance with another implementation, the injecting the beam includes or comprises transmitting the beam from the light source assembly to the imaging system by way of one or more waveguides.

In accordance with another implementation, the one or more waveguides are one or more optical fibers coupled to the imaging system.

In accordance with another implementation, the flow cell is stationary.

In accordance with another implementation, the imaging includes or comprises moving the housing along at least one of a first axis by way of an x-stage of the stage assembly or a second axis by way of a y-stage of the stage assembly to image the flow cell.

In accordance with another implementation, the imaging includes or comprises moving the light source assembly along at least one of the first axis or the second axis. The light source assembly is coupled to the y-stage.

In accordance with another implementation, the imaging further includes or comprises moving a second stage along at least one of the first axis or the second axis. The light source assembly is coupled to the second stage.

In accordance with another implementation, injecting the beam includes or comprises transmitting the beam from the light source assembly to the imaging system by way of an optical receiver and one or more waveguides.

In accordance with another implementation, the optical receiver is coupled to a second stage.

In accordance with another implementation, the method includes or comprises directing the beam between the light source assembly and the optical assembly using a first directional optical element and a second directional optical element.

In accordance with another implementation, directing the beam between the light source assembly and the optical assembly using the first directional optical element and the second directional optical element, includes or comprises: directing the beam to the first directional optical element coupled to a second stage; and directing the beam from the first directional optical element to the second directional optical element coupled to the stage assembly; and directing the beam from the second directional optical element to an optical receiver.

In accordance with another implementation, directing the beam between the light source assembly and the optical assembly using the first directional optical element and the second directional optical element, includes or comprises: directing the beam to the first directional optical element coupled to a second stage; and directing the beam from the first directional optical element to the second directional optical element coupled to the housing; and directing the beam from the second directional optical element to the optical assembly.

In accordance with another implementation, the stage assembly comprises or includes a stage.

In accordance with another implementation, the stage comprises or includes an x-stage.

In accordance with another implementation, the stage comprises or includes a y-stage.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 illustrates an isometric top view of an example imaging system that can be used to implement the imaging system of FIG. 1.

FIG. 3 illustrates an isometric top view of another example imaging system that can be used to implement the imaging system of FIG. 1.

FIG. 4 illustrates an isometric top view of another example imaging system that can be used to implement the imaging system of FIG. 1.

FIG. 5 illustrates an isometric top view of another example imaging system that can be used to implement the imaging system of FIG. 1.

FIG. 6 illustrates an isometric top view of another example imaging system that can be used to implement the imaging system of FIG. 1.

FIG. 7 illustrates another isometric top view of the imaging system of FIG. 1 with the sliding block of the second stage positioned at the left travel limit.

FIG. 8 illustrates an isometric top view of another example imaging system that can be used to implement the imaging system of FIG. 1.

FIG. 9 illustrates an isometric top view of another example imaging system that can be used to implement the imaging system of FIG. 1.

FIG. 10 illustrates an isometric top view of another example imaging system that can be used to implement the imaging system of FIG. 1.

FIG. 11 illustrates an isometric top view of another example imaging system that can be used to implement the imaging system of FIG. 1.

FIG. 12 illustrates a flow chart for a process of using the system of FIG. 1 and/or any of the imaging systems disclosed herein.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

The implementations disclosed herein relate to instruments (e.g., sequencing instruments) and related imaging systems and methods that are able to image relatively large flow cells/substrates and/or a larger number of flow cells/substrates. The imaging systems disclosed also have relatively fast focus times and, thus, obtain image data faster and have reduced cycle times. The instruments to do so have imaging systems that move relative to a flow cell interface carrying a flow cell and obtain image data that is used to form a time delay and integration (TDI) image. The flow cell interface may be stationary while the imaging system moves relative thereto.

The imaging system can include an imaging device, an optical assembly, a housing carrying the imaging device and the optical assembly, and a stage that moves the housing relative to the flow cell interface. The imaging system obtains image data associated with the flow cell while the imaging device moves and the flow cell is stationary. The imaging system also includes a light source assembly that emits a beam that is received by the optical assembly. A waveguide, such as an optical fiber or a rigid light pipe, can couple the beam emitted by the light source and the imaging system. Other ways of coupling the light source assembly and the imaging system can be used, however.

The light source assembly is stationary and, thus, does not move with the housing carrying the optical assembly in some implementations and the light source moves with and/or relative to the housing carrying the optical assembly in other implementations. The light source assembly can be coupled to the same stage that moves the housing and related components or the light source assembly, an associated receiver, or one or more directional optical elements can be coupled to a separate stage and can move relative to the stage along a first axis and/or a first axis and a second axis.

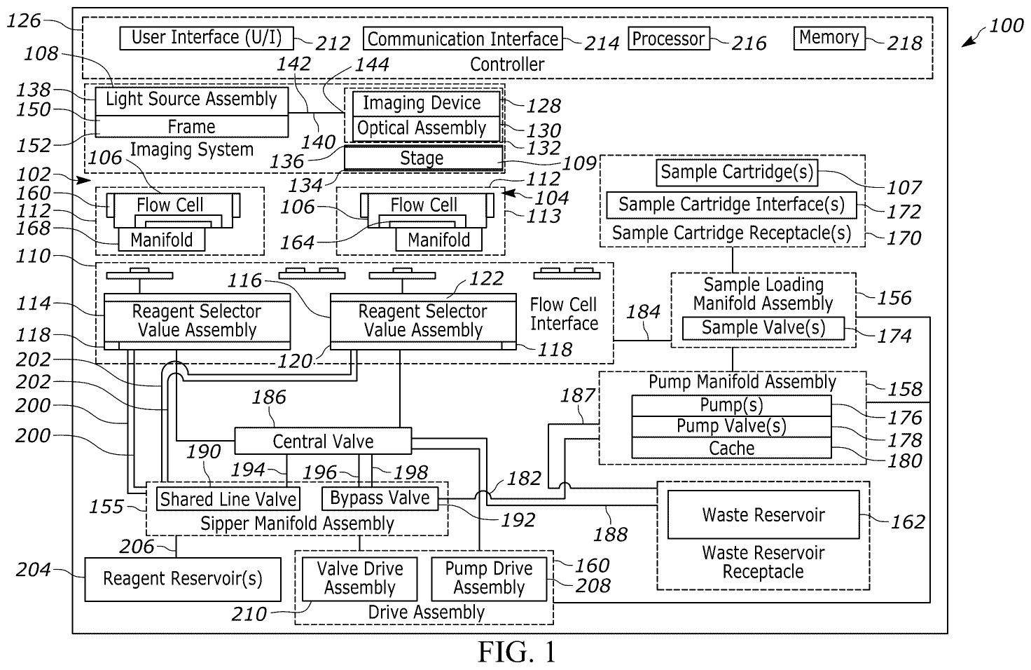

FIG. 1 illustrates a schematic diagram of an implementation of a system 100 in accordance with the teachings of this disclosure. The system 100 can be used to perform an analysis such as optical scanning and/or line scanning on one or more samples of interest. The sample may include one or more DNA clusters that have been linearized to form a single stranded DNA (sstDNA). In the implementation shown, the system 100 receives a pair of flow cell assemblies 102, 104 including corresponding flow cells 106 and a sample cartridge 107 and includes, in part, an imaging system 108 including a stage assembly 109 and a flow cell interface 110 having flow cell receptacles 112, 113 that support the corresponding flow cell assemblies 102, 104. While two flow cell interfaces 110 and the flow cell receptacles 112,113 are shown, any number of flow cell interfaces 110 and flow cell receptacles 112, 113 may be included. The flow cell interface 110 may be associated with and/or referred to as a flow cell deck structure. The system 100 also includes a pair of reagent selector valve assemblies 114, 116 that each include a reagent selector valve 118 and a valve drive assembly 120, a drive assembly 160 and a controller 126. The reagent selector valve assemblies 114, 116 may be referred to as mini-valve assemblies. The controller 126 is electrically and/or communicatively coupled to the imaging system 108, the reagent selector valve assemblies 114, 116, and to the drive assembly 160 and is adapted to cause the imaging system 108, the reagent selector valve assemblies 114, 116, and the drive assembly 160 to perform various functions as disclosed herein.

The imaging system 108 includes an imaging device 128, an optical assembly 130, a housing 132 carrying the imaging device 128 and the optical assembly 130. The imaging system 108 also includes the stage assembly 109 coupled to the housing 132 and having an x-stage 134 and a y-stage 136, and a light source assembly 138 that emits a beam that is received by the optical assembly 130. The housing 132 and the stage assembly 109 may be made from a metal, such as aluminum with steel, or made from a plastic. The light source assembly 138 may be a laser diode illuminator (LDI). The stage assembly 109 can alternatively be a one-dimensional stage.

The stage assembly 109 in operation moves the housing 132 relative to the flow cell interface 110 to allow the imaging device 128 to obtain image data from the flow cell assembly 102. The flow cell interfaces 110 holds the flow cell assemblies 102, 104 and the stage assembly 109 moves the imaging device 128 relative to the flow cell assemblies 102, 104 and scans and images the flow cells 106. The stage assembly 109 may be a linear stage and may move by way of a linear motor and/or an actuator. While the stage assembly 109 is shown including both the x-stage 134 and the y-stage 136, sometimes referred to as an x-y stage, the stage assembly 109 may include one of the x-stage and the y-stage. The system 100 may include another stage assembly that is used to move the flow cell interfaces 110 and the corresponding flow cell assemblies 102, 104 relative to the imaging system 108 in such implementations.

The imaging device 128 is a time delay and integration (TDI) imaging device in some implementations and includes a camera, a sensor, and/or a microprocessor or a computing device to allow the imaging device 128 to analyze the received light from the optical assembly 130. The imaging device 128 may alternatively function as a sensor and the image data can be accessed by a separate computing device (not shown) via one or more cables and/or wireless interfaces.

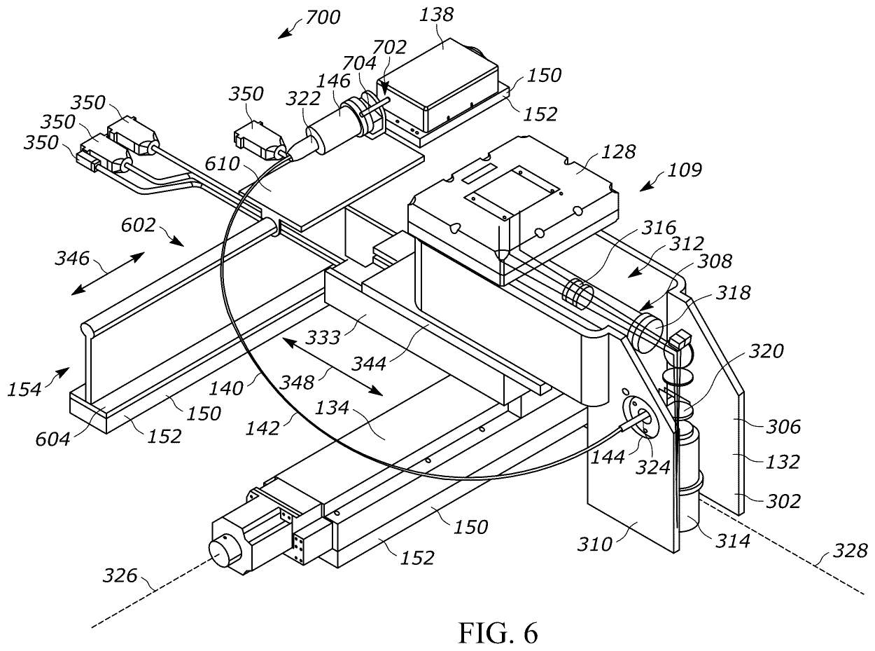

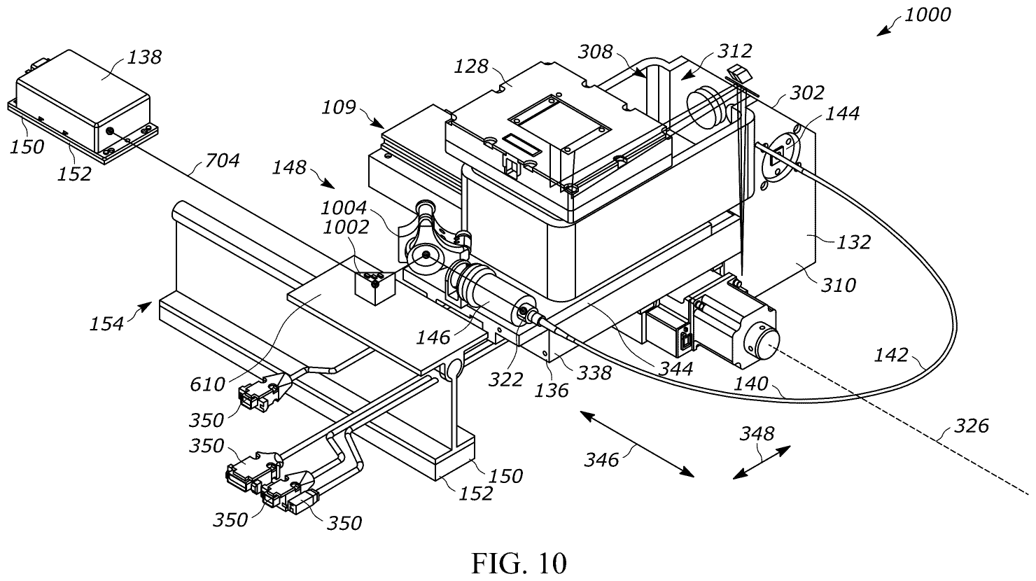

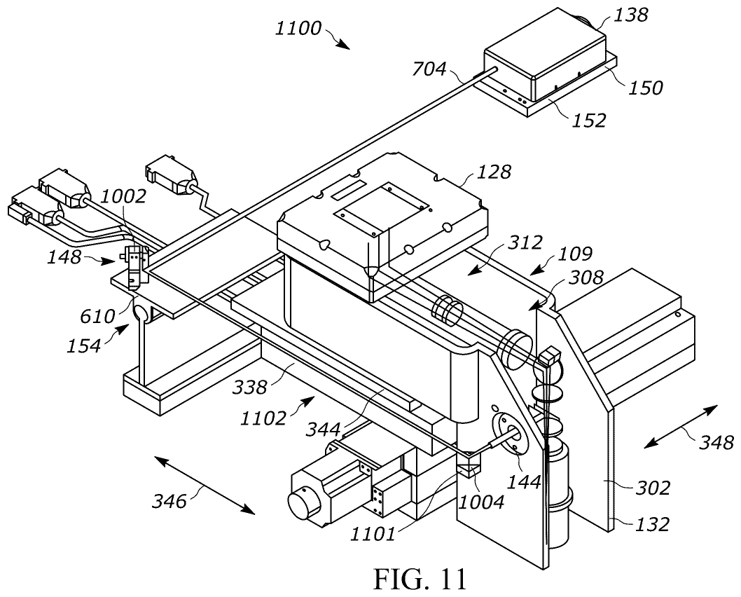

The imaging system 108 also includes a waveguide 140 that is coupled to the optical assembly 130. The waveguide 140 may be referred to as an optical connection. The waveguide 140 is shown being an optical fiber 142 coupled to and between the light source assembly 138 and the optical assembly 130. The optical fiber 142 may alternatively be omitted. The housing 132 is shown including a waveguide port 144 to which the optical fiber 142 is coupled and the waveguide port 144 can direct the beam emitted by the light source assembly 138 onto the optical assembly 130. The optical fiber 142 is shown directly coupled to and between the light source assembly 138 and the waveguide port 144. The light source assembly 138 can, however, be coupled to the optical assembly 130 in different ways such as using an optical receiver 146 (see, FIGS. 6-9) and/or using one or more directional optical elements 148 (See, FIGS. 10 and 11).

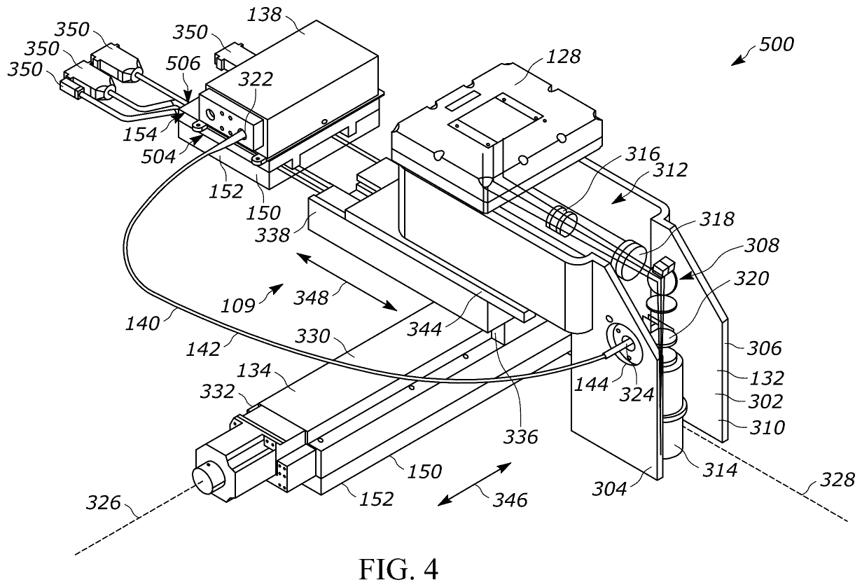

Referring still to the optical fiber 142, the optical fiber 142 is bendable and, as a result, the stage assembly 109 carrying the housing 132, the imaging device 128, and the optical assembly 130 can move relative to the light source assembly 138 and a shape of the optical fiber 142 may change to accommodate movement. The system 100 also includes a portion 150 and the light source assembly 138 is coupled to the portion 150 to allow the stage assembly 109 to move relative to the light source assembly 138. The light source assembly 138 may be stationary and the stage assembly 109 can move relative to the light source assembly 138. The portion 150 may be a frame 152 of the system 100. While the light source assembly 138 is mentioned being coupled to the frame 152 of the system 100, the system 100 may alternatively include a second stage 154 (see, FIGS. 4-11) and the light source assembly 138 may be coupled to the second stage 154. Other components such as the optical receiver 146 (see, FIGS. 6-10) and/or one or more directional optical elements 148 (See, FIGS. 10-11) may alternatively be coupled to the second stage 154.

Referring still to the system 100 of FIG. 1, the system 100 also includes a sipper manifold assembly 155, a sample loading manifold assembly 156, a pump manifold assembly 158, a drive assembly 160, and a waste reservoir 162 in the implementation shown. The controller 126 is electrically and/or communicatively coupled to the sipper manifold assembly 155, the sample manifold assembly 156, the pump manifold assembly 158, and the drive assembly 160 and is adapted to cause the sipper manifold assembly 155, the sample manifold assembly 156, the pump manifold assembly 158, and the drive assembly 160 to perform various functions as disclosed herein.

Referring to the flow cells 106, each of the flow cells 106 includes a plurality of channels 164 in the implementation shown, each having a first channel opening positioned at a first end of the flow cell 106 and a second channel opening positioned at a second end of the flow cell 106. Depending on the direction of flow through the channels 164, either of the channel openings may act as an inlet or an outlet. While the flow cells 106 are shown including two channels 164 in FIG. 1, any number of channels 164 may be included (e.g., 1, 2, 6, 8).

Each of the flow cell assemblies 102, 104 also includes a flow cell frame 166 and a flow cell manifold 168 coupled to the first end of the corresponding flow cell 106. As used herein, a “flow cell” (also referred to as a flowcell) can include a device having a lid extending over a reaction structure to form a flow channel therebetween that is in communication with a plurality of reaction sites of the reaction structure. Some flow cells may also include a detection device that detects designated reactions that occur at or proximate to the reaction sites. As shown, the flow cell 106, the flow cell manifold 168, and/or any associated gaskets used to establish a fluidic connection between the flow cell 106 and the system 100 are coupled or otherwise carried by the flow cell frame 166. While the flow cell frame 166 is shown included with the flow cell assemblies 102, 104 of FIG. 1, the flow cell frame 166 may be omitted. As such, the flow cell 106 and the associated flow cell manifold 168 and/or gaskets may be used with the system 100 without the flow cell frame 166.

Prior to referring to some of the additional components of the system 100 of FIG. 1 such as some of the fluidic components, it is noted that while some components of the system 100 are shown once and being coupled to both of the flow cells 106, in some implementations, these components may be duplicated such that each flow cell 106 has its own corresponding components. For example, each flow cell 106 may be associated with a separate sample cartridge 107, sample loading manifold assembly 156, pump manifold assembly 158, etc. In other implementations, the system 100 may include a single flow cell 106 and corresponding components.

Referring now to the sample cartridge 107, the sample loading manifold assembly 156, and the pump manifold assembly 158, in the implementation shown, the system 100 includes a sample cartridge receptacle 170 that receives the sample cartridge 107 that carries one or more samples of interest (e.g., an analyte). The system 100 also includes a sample cartridge interface 172 that establishes a fluidic connection with the sample cartridge 107.

The sample loading manifold assembly 156 includes one or more sample valves 174 and the pump manifold assembly 158 includes one or more pumps 176, one or more pump valves 178, and a cache 180. One or more of the valves 174, 178 may be implemented by a rotary valve, a pinch valve, a flat valve, a solenoid valve, a check valve, a piezo valve, and/or a three-way valve. Different types of fluid control devices may be used, however. One or more of the pumps 176 may be implemented by a syringe pump, a peristaltic pump, and/or a diaphragm pump. Other types of fluid transfer devices may be used, however. The cache 180 may be a serpentine cache and may temporarily store one or more reaction components during, for example, bypass manipulations of the system 100 of FIG. 1. While the cache 180 is shown being included in the pump manifold assembly 158, in another implementation, the cache 180 may be located in a different location. The cache 180 may be included in the sipper manifold assembly 155 or in another manifold downstream of a bypass fluidic line 182, for example.

The sample loading manifold assembly 156 and the pump manifold assembly 158 flow one or more samples of interest from the sample cartridge 107 through a fluidic line 184 toward the flow cell assembly 102, 104. In some implementations, the sample loading manifold assembly 156 can individually load/address each channel 164 of the flow cell 106 with a sample of interest. The process of loading the channels 164 of the flow cell 106 with a sample of interest may occur automatically using the system 100 of FIG. 1.

As shown in the system 100 of FIG. 1, the sample cartridge 107 and the sample loading manifold assembly 156 are positioned downstream of the flow cell assemblies 102, 104. The sample loading manifold assembly 156 may thus load a sample of interest into the flow cell 106 from the rear of the flow cell 106. Loading a sample of interest from the rear of the flow cell 106 may be referred to as “back loading.” Back loading the sample of interest into the flow cell 106 may reduce contamination. The sample loading manifold assembly 156 is coupled between the flow cell assemblies 102, 104 and the pump manifold assembly 158, in the implementation shown.

To draw a sample of interest from the sample cartridge 107 and toward the pump manifold assembly 158, the sample valves 174, the pump valves 178, and/or the pumps 176 may be selectively actuated to urge the sample of interest toward the pump manifold assembly 158. The sample cartridge 107 may include a plurality of sample reservoirs that are selectively fluidically accessible via the corresponding sample valve 174. Thus, each sample reservoir can be selectively isolated from other sample reservoirs using the corresponding sample valves 174.

To individually flow the sample of interest toward a corresponding channel of one of the flow cells 106 and away from the pump manifold assembly 158, the sample valves 174, the pump valves 178, and/or the pumps 176 can be selectively actuated to urge the sample of interest toward the flow cell assembly 102 and into the respective channels 164 of the corresponding flow cell 106. In some implementations, each channel 164 of the flow cell 106 receives the sample of interest. In other implementations, one or more of the channels 164 of the flow cell(s) 106 selectively receives the sample of interest and others of the channels 164 of the flow cell(s) 106 do not receive the sample of interest. The channels 164 of the flow cell(s) 106 that may not receive the sample of interest may receive a wash buffer instead, for example.

The drive assembly 160 interfaces with the sipper manifold assembly 155 and the pump manifold assembly 158 to flow one or more reagents that interact with the sample within the corresponding flow cell 106. In an implementation, a reversible terminator is attached to the reagent to allow a single nucleotide to be incorporated onto a growing DNA strand. In some such implementations, one or more of the nucleotides has a unique fluorescent label that emits a color when excited. The color (or absence thereof) is used to detect the corresponding nucleotide. The imaging system 108 excites one or more of the identifiable labels (e.g., a fluorescent label) in the implementation shown and thereafter obtains image data for the identifiable labels. The labels may be excited by incident light and/or a laser and the image data may include one or more colors emitted by the respective labels in response to the excitation. The image data (e.g., detection data) may be analyzed by the system 100. The imaging system 108 may be a fluorescence spectrophotometer including an objective lens and/or a solid-state imaging device. The solid-state imaging device may include a charge coupled device (CCD) and/or a complementary metal oxide semiconductor (CMOS). Other types of imaging systems and/or optical instruments may be used, however. For example, the imaging system 108 may be or be associated with a scanning electron microscope, a transmission electron microscope, an imaging flow cytometer, high-resolution optical microscopy, confocal microscopy, epifluorescence microscopy, two photon microscopy, differential interference contrast microscopy, etc.

After the image data is obtained, the drive assembly 160 interfaces with the sipper manifold assembly 155 and the pump manifold assembly 158 to flow another reaction component (e.g., a reagent) through the flow cell 106 that is thereafter received by the waste reservoir 162 via a primary waste fluidic line 187 and/or otherwise exhausted by the system 100. Some reaction components perform a flushing operation that chemically cleaves the fluorescent label and the reversible terminator from the sstDNA. The sstDNA is then ready for another cycle.

The primary waste fluidic line 187 is coupled between the pump manifold assembly 158 and the waste reservoir 162. The pumps 176 and/or the pump valves 178 of the pump manifold assembly 158 selectively flow the reaction components from the flow cell assembly 102, 104, through the fluidic line 184 and the sample loading manifold assembly 156 to the primary waste fluidic line 187, in some implementations.

The flow cell assembly 102, 104 is coupled to a central valve 186 via the flow cell interface 110. An auxiliary waste fluidic line 188 is coupled to the central valve 186 and to the waste reservoir 162. The auxiliary waste fluidic line 188 receives excess fluid of a sample of interest from the flow cell assembly 102, 104, via the central valve 186 in some implementations, and flows the excess fluid of the sample of interest to the waste reservoir 162 when back loading the sample of interest into the flow cell 106, as described herein. That is, the sample of interest may be loaded from the rear of the flow cell 106 and any excess fluid for the sample of interest may exit from the front of the flow cell 106. By back loading samples of interest into the flow cell 106, different samples can be separately loaded to corresponding channels 164 of the corresponding flow cell 106 and the single flow cell manifold 168 can couple the front of the flow cell 106 to the central valve 186 to direct excess fluid of each sample of interest to the auxiliary waste fluidic line 188. Once the samples of interest are loaded into the flow cell 106, the flow cell manifold 168 can be used to deliver common reagents from the front of the flow cell 106 (e.g., upstream) for each channel 164 of the flow cell 106 that exit from the rear of the flow cell 106 (e.g., downstream). Put another way, the sample of interest and the reagents may flow in opposite directions through the channels 164 of the flow cell 106.

Referring to the sipper manifold assembly 155, in the implementation shown, the sipper manifold assembly 155 includes a shared line valve 190 and a bypass valve 192. The shared line valve 190 may be referred to as a reagent selector valve. The valves 118 of the reagent selector valve assemblies 114, 116, the central valve 186 and/or the valves 190, 192 of the sipper manifold assembly 155 may be selectively actuated to control the flow of fluid through fluidic lines 194, 196, 198, 200, 202. One or more of the valves 118, 174, 178, 186, 190, 192 may be implemented by a rotary valve, a pinch valve, a flat valve, a solenoid valve, a check valve, a piezo valve, etc. Other fluid control devices may prove suitable.

The sipper manifold assembly 155 may be coupled to a corresponding number of reagents reservoirs 204 via reagent sippers 206. The reagent reservoirs 204 may contain fluid (e.g., reagent and/or another reaction component). In some implementations, the sipper manifold assembly 155 includes a plurality of ports. Each port of the sipper manifold assembly 155 may receive one of the reagent sippers 206. The reagent sippers 206 may be referred to as fluidic lines.

The shared line valve 190 of the sipper manifold assembly 155 is coupled to the central valve 186 via the shared reagent fluidic line 194. Different reagents may flow through the shared reagent fluidic line 194 at different times. In an implementation, when performing a flushing operation before changing between one reagent and another, the pump manifold assembly 158 may draw wash buffer through the shared reagent fluidic line 194, the central valve 186, and the corresponding flow cell assembly 102, 104. Thus, the shared reagent fluidic line 194 may be involved in the flushing operation. While one shared reagent fluidic line 194 is shown, any number of shared fluidic lines may be included in the system 100. While system 100 is shown including the simper manifold assembly 155, the sipper manifold assembly 155 may be omitted and the system 100 may instead receive a reagent cartridge and the system 100 may pump reagent from that reagent cartridge through the system 100 under positive pressure or negative pressure.

The bypass valve 192 of the sipper manifold assembly 155 is coupled to the central valve 186 via the reagent fluidic lines 196, 198. The central valve 186 may have one or more ports that correspond to the reagent fluidic lines 196, 198.

The dedicated reagent fluidic lines 200, 202 are coupled between the sipper manifold assembly 155 and the reagent selector valve assemblies 114, 116. Each of the dedicated reagent fluidic lines 200, 202 may be associated with a single reagent. The fluids that may flow through the dedicated reagent fluidic lines 200, 202 may be used during sequencing operations and may include a cleave reagent, an incorporation reagent, a scan reagent, a cleave wash, and/or a wash buffer. Thus, because only a single reagent may flow through each of the dedicated reagent fluidic lines 200, 202 the dedicated reagent fluidic lines 200, 202 themselves may not be flushed when performing a flushing operation before changing between one reagent and another. The approach of including dedicated reagent fluidic lines 200, 202 may be advantageous when the system 100 uses reagents that may have adverse reactions with other reagents. Moreover, reducing a number of fluidic lines or length of the fluidic lines that are flushed when changing between different reagents reduces reagent consumption and flush volume and may decrease cycle times of the system 100. While four dedicated reagent fluidic lines 200, 202 are shown, any number of dedicated fluidic lines may be included in the system 100.

The bypass valve 192 is also coupled to the cache 180 of the pump manifold assembly 158 via the bypass fluidic line 182. One or more reagent priming operations, hydration operations, mixing operations, and/or transfer operations may be performed using the bypass fluidic line 182. The priming operations, the hydration operations, the mixing operations, and/or the transfer operations may be performed independent of the flow cell assembly 102, 104. Thus, the operations using the bypass fluidic line 182 may occur during, for example, incubation of one or more samples of interest within the flow cell assembly 102, 104. That is, the shared line valve 190 can be utilized independently of the bypass valve 192 such that the bypass valve 192 can utilize the bypass fluidic line 182 and/or the cache 180 to perform one or more operations while the shared line valve 190 and/or the central valve 186 simultaneously, substantially simultaneously, or offset synchronously perform other operations. The system 100 can, thus, perform multiple operations at once, thereby reducing run time.

Referring now to the drive assembly 160, in the implementation shown, the drive assembly 160 includes a pump drive assembly 208 and a valve drive assembly 210. The pump drive assembly 208 may be adapted to interface with the one or more pumps 176 to pump fluid through the flow cell 106 and/or to load one or more samples of interest into the flow cell 106. The valve drive assembly 210 may be adapted to interface with one or more of the valves 174, 178, 186, 190, 192 to control the position of the corresponding valves 174, 178, 186, 190, 192.

Referring to the controller 126, in the implementation shown, the controller 126 includes a user interface 212, a communication interface 214, one or more processors 216, and a memory 218 storing instructions executable by the one or more processors 216 to perform various functions including the disclosed implementations. The user interface 212, the communication interface 214, and the memory 218 are electrically and/or communicatively coupled to the one or more processors 216.

In an implementation, the user interface 212 is adapted to receive input from a user and to provide information to the user associated with the operation of the system 100 and/or an analysis taking place. The user interface 212 may include a touch screen, a display, a keyboard, a speaker(s), a mouse, a track ball, and/or a voice recognition system. The touch screen and/or the display may display a graphical user interface (GUI).

In an implementation, the communication interface 214 is adapted to enable communication between the system 100 and a remote system(s) (e.g., computers) via a network(s). The network(s) may include the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 216 and/or the system 100 may include one or more of a processor-based system(s) or a microprocessor-based system(s). In some implementations, the one or more processors 216 and/or the system 100 includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit, and/or another logic-based device executing various functions including the ones described herein.

The memory 218 can include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache and/or any other storage device or storage disk in which information is stored for any duration (e.g., permanently, temporarily, for extended periods of time, for buffering, for caching).

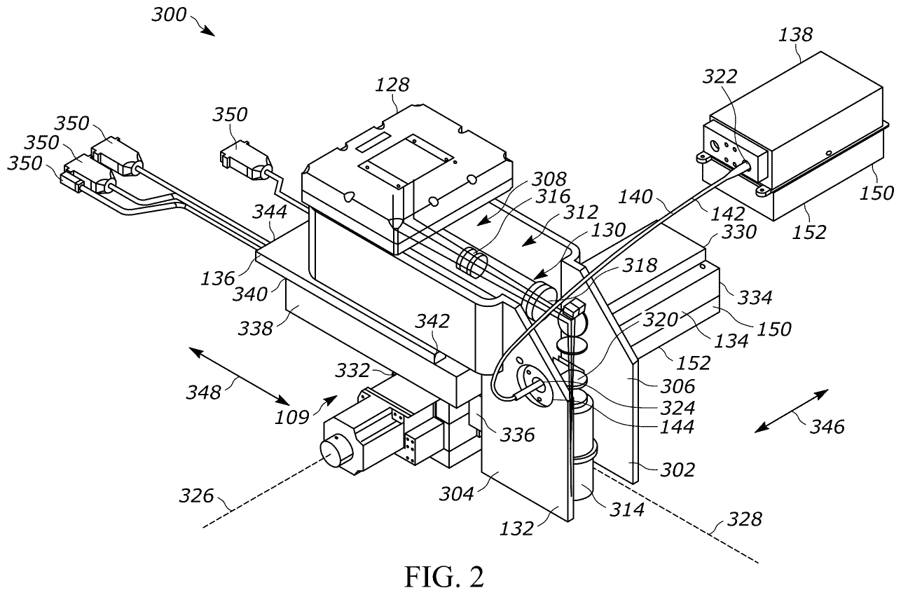

FIG. 2 illustrates an isometric top view of an example imaging system 300 that can be used to implement the imaging system 108 of FIG. 1. The imaging system 300 includes the housing 132 that carries the imaging device 128 and the optical assembly 130 and is coupled to the y-stage 136. The light source assembly 138 is shown coupled to the frame 152.

The housing 132 includes an L-shaped housing 302 having opposing first and second side walls 304, 306 that define an L-shaped channel 308. The optical assembly 130 is shown disposed within the L-shaped channel 308 and the imaging device 128 is coupled to the first and second side walls 304, 306. The side walls 304, 306 define an opening 310 that allows the imaging device 128 and the optical assembly 130 to optically access the flow cell interface 110 and the associated flow cell assemblies 102, 104, for example.

The optical assembly 130 includes at least one lens group 312 and an entry aperture 314 through which the optical assembly 130 receives light from the flow cells 106 and that is disposed within the L-shaped channel 308. The optical assembly 130 as a result is coupled to the imaging device 128 as a result. The lens group 312 includes a plurality of lenses 316, 318, 320 in the implementation shown and one or more lenses 316, 318, 320 of the lens group 312 may be made of crown glass, flint glass, crown plastic, flint plastic, or any other similarly suitable material depending on the implementation. The lens group 312, however, may include any number of lenses. Each lens 316, 318, 320 in the lens group 312 may further be closer or farther apart than indicated in FIG. 2. The optical assembly 130 may moreover include additional lens groups beyond the lens group 312, in some implementations.

The first side wall 304 of the housing 132 defines the waveguide port 144 and the waveguide 140 includes a first end 322 and a second end 324. The first end 322 of the waveguide 140 is coupled to the light source assembly 138 and the second end 324 of the waveguide 140 is coupled to the waveguide port 144.

The light source assembly 138 emits a beam in operation and the optical assembly 130 uses the beam injected from the light source assembly 138 to illuminate the flow cell 106 or a sample of interest within the flow cell 106. The entry aperture 314 receives light from the flow cell 106 or the sample of interest within the flow cell 106 and directs the light to the lens groups 312 and subsequently to the imaging device 128 coupled to the optical assembly 130 to allow the imaging device 128 to obtain image data of the flow cell interface 110 and/or the associated flow cell 106. The image data obtained may be used to produce a time delay and integration (TDI) image. The x-stage 134 and the y-stage 136 move along a first axis 326 and a second axis 328 to allow the imaging device 128 to perform a time delay and integration (TDI) scanning procedure while the light source assembly 138 remains stationary in the implementation shown. The x-stage 134 is shown coupled to the frame 152 and has a rail 330 having a left travel limit 332 and a right travel limit 334 and a block 336 coupled to the rail 330. The y-stage 136 is shown having a rail 338 having a front travel limit 340 and a back travel limit 342 and a block 344 coupled to the rail 338. The rail 338 of the y-stage 136 is coupled to the block 336 of the x-stage 134. Fasteners, screws, welding, adhesive, or any other technique can be used to couple the x-stage 134 and the y-stage 136. The x-stage 134 is confined to a range of motion defined by the rail 330 along the first axis 326 in the implementation shown and the y-stage 136 moves along the second axis 328 perpendicular to the first axis 326.

The x-stage 134 is shown in FIG. 2 positioned at the left travel limit 332 and the y-stage 136 is positioned at the back travel limit 342. The x-stage 134 can, however, move along the rail 330 to the right travel limit 334 in a direction generally indicated by arrow 346 the y-stage 136 can move along the rail 338 and relative to the x-stage 134 from the back travel limit 342 to the front travel limit 340 in a direction generally indicated by arrow 348. The movement of the stage assembly 109 between the travel limits 332, 334, 340, 342 causes the waveguide 140 to bend in one or more dimensions.

The imaging system 300 also includes network cables 350 that are couplable to the system 100 to allow the controller 126 to provide signals/commands to the imaging system 300. The controller 126 can provide commands to move the x-stage 134 and/or the y-stage 136, for example. An external computing device may alternatively control the imaging system 300 through signals sent to the communication interface 214 of the controller 126.

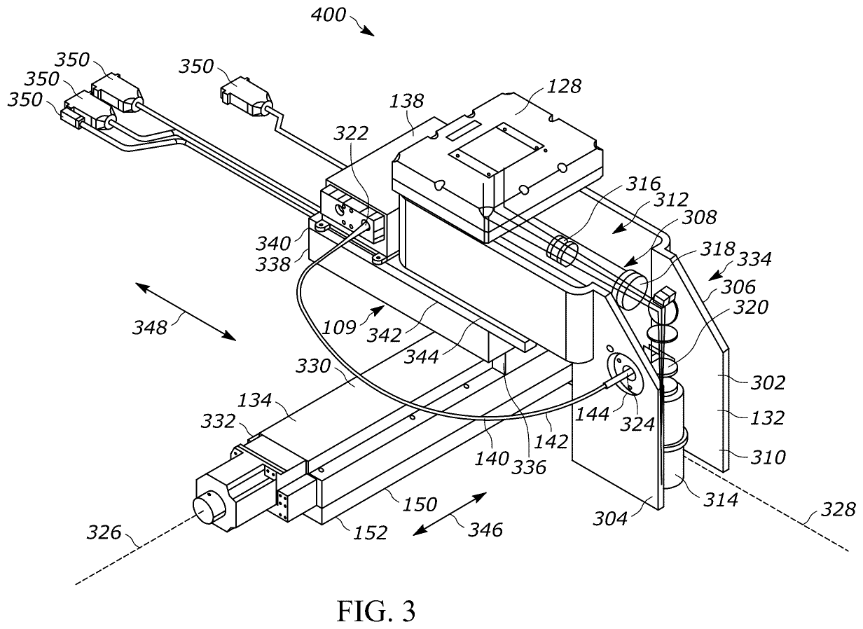

FIG. 3 illustrates an isometric top view of another example imaging system 400 that can be used to implement the imaging system 108 of FIG. 1. The imaging system 400 is similar to the imaging system 300 of FIG. 2. The imaging system 400 of FIG. 3, however, includes the light source assembly 138 coupled to the y-stage 136. The light source assembly 138 is thus coupled to the stage assembly 109. A size of the block 344 of the y-stage 136 may be increased relative to the size of the block 344 of FIG. 2 to better accommodate the light source assembly 138 being coupled to the block 344. The mass and/or heat on the y-stage 136 may increase as a result of coupling the light source assembly 138 to the y-stage 136. The y-stage 136 can include a heat sink or may be modified to better distribute heat away from the rest of the y-stage 136 and/or the imaging system 400, as a result.

The light source assembly 138 in the implementation shown moves with the y-stage 136 along the second axis 328 and the waveguide 140 and/or the optical fiber 142 do not substantially change shape. Put another way, the relative positioning of the first end 322 of the waveguide 140 coupled to the light source assembly 138 and the second end 324 of the waveguide 140 coupled to the waveguide port 144 remains substantially similar or the same when the x-stage 134 and/or the y-stage 136 move. The waveguide 140 may not substantially stretch, compress, or bend when the x-stage 134 and/or y-stage 136 moves as a result, other than shape changes due to the movement of the waveguide 140, gravity, air. For example, a distance between a start/the first end 322 of the waveguide 140 at the light source assembly 138 and the end/the second end 324 of the waveguide 140 at the waveguide port 144 remains substantially consistent when the y-stage 136 moves from the front travel limit 340 depicted in FIG. 3 to the back travel limit 342. The distance between the start/the first end 322 of the waveguide 140 at the light source assembly 138 and the end/the second end 324 of the waveguide 140 similarly remains substantially consistent when the x-stage 134 moves along the rail 330 from the right travel limit 334 to the left travel limit 332 along the rail 330. The reduced movement and bending of the waveguide 140 may lead to reduced wear and tear on the waveguide 140 and, thus, the lifespan of the waveguide 140 may be increased as a result.

FIG. 4 illustrates an isometric top view of another example imaging system 500 that can be used to implement the imaging system 108 of FIG. 1. The imaging system 500 is similar to the imaging system 400 of FIG. 3. The imaging system 500 includes the second stage 154 to which the light source assembly 138 is coupled. The second stage 154 carrying the light source assembly 138 instead of the stage assembly 109 itself decouples heat and vibration of the light source assembly 138 from the stage assembly 109.

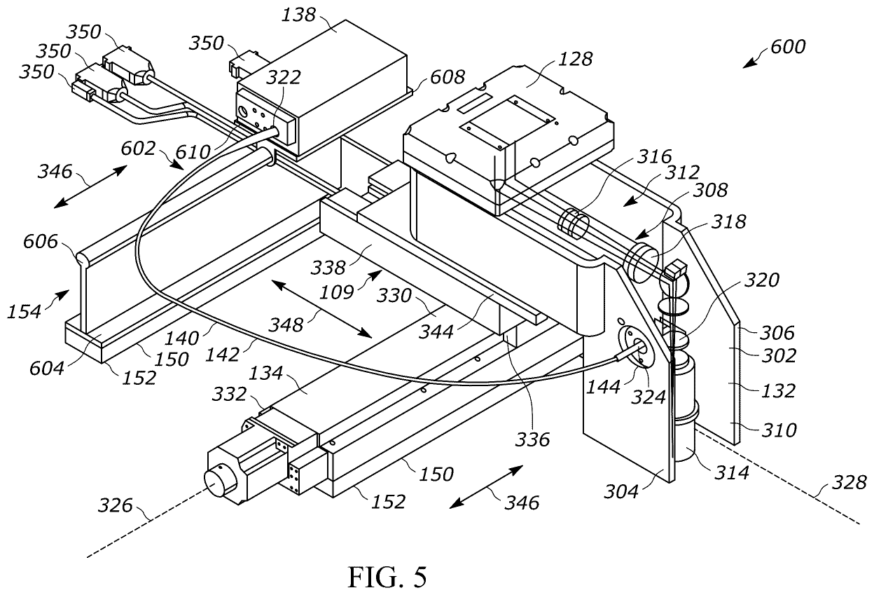

The second stage 154 may be an x-y stage 504 and is shown coupled to the frame 152 of the system 100. The second stage 154 may move the light source assembly 138 in the directions generally indicated by arrows 346, 348 as a result and in a manner that corresponds to the movement of the stage assembly 109. Put another way, the stage assembly 109 and the second stage 154 move in substantially the same directions at about the same times to reduce bending stress imparted on the waveguide 140. Precision requirements may be less stringent for the second stage 154 as the second stage 154 is not directly responsible for the imaging in some implementations. The second stage 154 may be referred to as a follower stage 506 that moves corresponding to movement of the stage assembly 109. The second stage 154 may alternatively be a one-dimensional stage such as an x-stage and/or a y-stage shown in FIGS. 5-11. Adding the light source assembly 138 to the second stage 154 generally introduces some additional mass to the system 100, however, an overall effect to the main body of the imaging system 500 such as those components associated with heat and/or vibration may be reduced because the light source assembly 138 is removed from the housing 132.

The system 100 can cause the second stage 154 of FIG. 4 to move corresponding to the movement of at least one of the x-stage 134 or the y-stage 136. The controller 126 may transmit commands to the stage assembly 109 and/or to the second stage 154 using the one or more network cables 350 to command the x-stage 134, the y-stage 136, and/or the second stage 154 to move a commanded distance, for example. The controller 126 may also cause the stage assembly 109 and/or the second stage 154 to move in conjunction with one another. While the controller 126 is mentioned commanding the movement of the stage assembly 109 and the second stage 154, an onboard microprocessor and/or computing device may be used to command the movement of the stage assembly 109 and/or the second stage 154.

FIG. 5 illustrates an isometric top view of another example imaging system 600 that can be used to implement the imaging system 108 of FIG. 1. The imaging system 600 is similar to the imaging system 500 of FIG. 4 in that the light source assembly 138 is coupled to the second stage 154. The second stage 154 of the imaging system 600 is, however, a one-dimensional movement stage 602. Put another way, the second stage 154 in FIG. 5 is an x-stage.

The second stage 154 of the implementation of FIG. 5 has a rail 604 having a left travel limit 606 and a right travel limit 608 and a sliding block 610 coupled to the rail 604. The rail 604 of the second stage 154 and the rail 330 of the stage assembly 109 are positioned shown substantially parallel to one another. The phrase “substantially parallel” as set forth means +/−5° of parallel including parallel itself and/or accounts for manufacturing tolerances. The substantially parallel positioning of the rails 338, 604 relative to one another allows the block 336 of the x-stage 134 of the stage assembly 109 and the sliding block 610 of the second stage 154 to move in tandem in directions generally indicated by the arrow 346. A relative positioning of the ends 322, 324 of the waveguide 140 can remain substantially consistent as a result. Put another way, the blocks 336, 610 move together and allow a shape of the waveguide 140 to remain substantially consistent, thereby reducing bending stress imparted on the waveguide 140. The second stage 154 does not, however, move in the direction generally indicated by arrow 348. The waveguide 140, thus, may change shape and/or bend when the block 344 of the y-stage 136 moves in a direction indicated by arrow 348 while the position of the second stage 154 along the second axis 328 remains the same.

The controller 126 may transmit commands to the stage assembly 109 and/or to the second stage 154 using the one or more network cables 350 to command the x-stage 134 and/or the second stage 154 to move a commanded distance. The x-stage 134 can communicate to the second stage 154 in some implementations and instructs the second stage 154 to move. The second stage 154 can alternatively instruct the x-stage 134 to move.

FIG. 6 illustrates an isometric top view of another example imaging system 700 that can be used to implement the imaging system 108 of FIG. 1. The imaging system 700 is similar to the imaging system 600 of FIG. 5. The imaging system 700 of FIG. 6, however, includes the optical receiver 146 and the waveguide 140 coupled to and between the optical receiver 146 and the optical assembly 130. The system 100 can also cause the stage assembly 109 and the second stage 154 to move together in the direction generally indicated by the arrow 346 and, thus, a shape of the waveguide 140 may remain substantially consistent. The system 100 can cause the second stage 154 to move the optical receiver 146 relative to the light source assembly 138. Bending stresses imparted on the waveguide 140 may be reduced based on the shape of the waveguide 140 remaining consistent. The optical receiver 146 is a fiber coupling lens in some implementations and/or is and/or includes any one of a collimator, a microlens array, a diffractive optical element, a Powell lens, a Lineman lens, a cylindrical lens, or an acylindrical lens. The optical receiver 146 can, however, be implemented in different ways.

The optical receiver 146 is coupled to the second stage 154 in the implementation shown and the light source assembly 138 is coupled to the frame 152 of the system 100. A free space 702 is defined between the light source assembly 138 and the optical receiver 146. The second stage 154, thus, moves the optical receiver 146 relative to the light source assembly 138. The light source assembly 138 is shown in FIG. 6 transmitting a beam 704 through the free space 702 and the optical receiver 146 is shown receiving the beam 704. The beam 704 can be a laser beam of any wavelength, such as a red beam or a green beam.

The light source assembly 138 being coupled to the frame 152 and not to the stage assembly 109 or the second stage 154 substantially decouples heat, mass, and/or vibration from the stage assembly 109 and the second stage 154. The optical receiver 146 that receives the beam 704 through the free space 702 allows the light source assembly 138 to be coupled to the frame 152 and/or remain substantially stationary, thereby reducing the mass carried by the second stage 154.

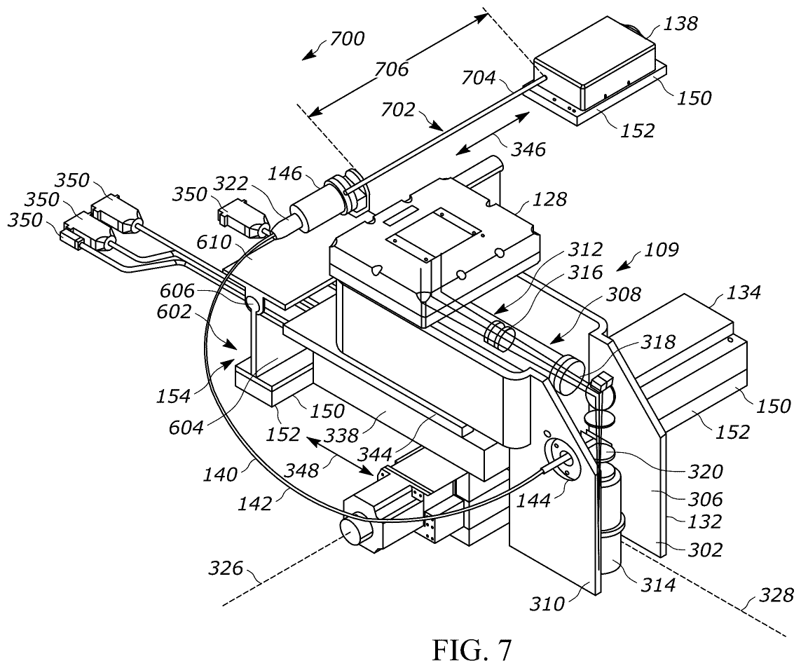

FIG. 7 illustrates another isometric top view of the imaging system 700 of FIG. 7 with the sliding block 610 of the second stage 154 positioned at the left travel limit 606. A distance 706 provided between the light source assembly 138 and the optical receiver 146 is thus greater than the distance between the light source assembly 138 and the optical receiver 146 shown in FIG. 6.

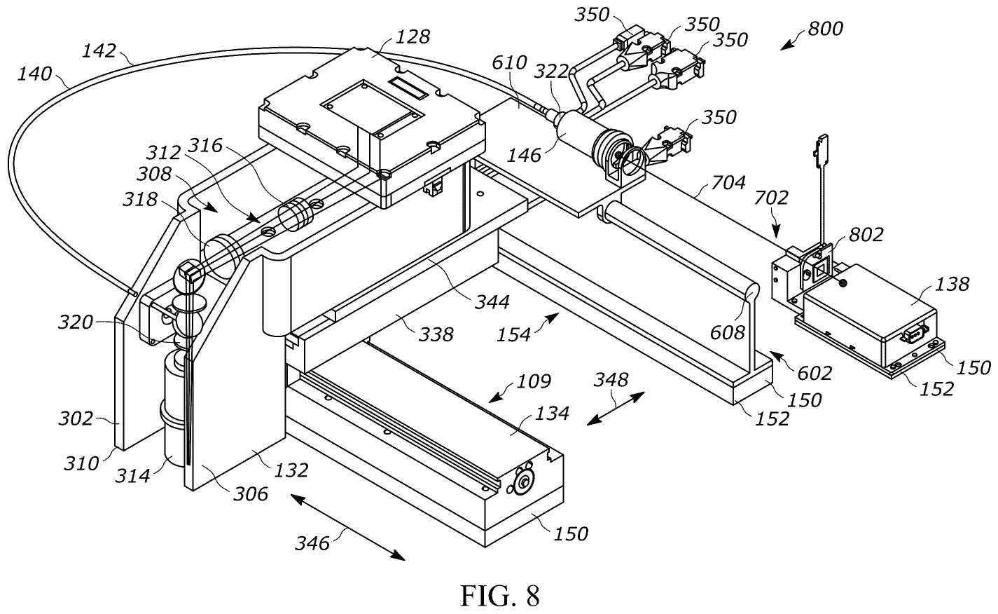

FIG. 8 illustrates an isometric top view of another example imaging system 800 that can be used to implement the imaging system 108 of FIG. 1. The imaging system 800 is similar to the imaging system 700 of FIG. 6. The imaging system 800 of FIG. 8, however, includes an external laser speckle reducer (LSR) 802 disposed perpendicular to the beam 704. The LSR 802 is coupled adjacent to the light source assembly 138 in the implementation shown. The LSR 802 can alternatively be internal to the light source assembly 138, internal to a waveguide 140, or positioned in a different location (See, for example, FIG. 8). Put another way, the LSR 802 can be positioned anywhere along the beam 704 between the light source assembly 138 and the optical receiver 146.

LSR 802 reduces speckle pattern functions as a diffuser to homogenize light intensity of the beam 704. The LSR 802 may have a central diffuser and electro-active polymers that selectively move the central diffuser in a circular pattern. The LSR 802 can adjust the speckle pattern of the beam 704 as a result so that the beam 704 appears as a uniform distribution of light.

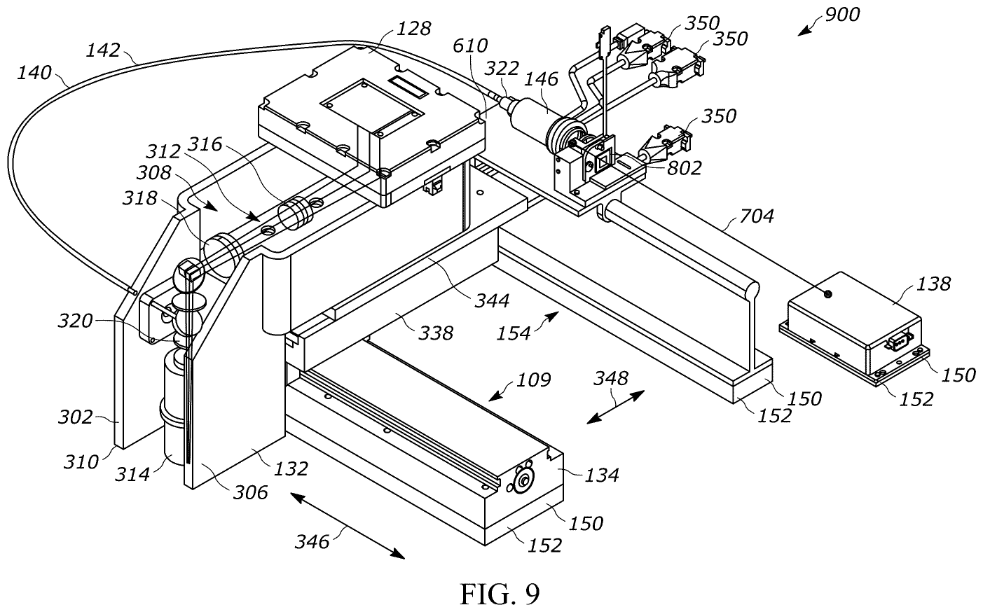

FIG. 9 illustrates an isometric top view of another example imaging system 900 that can be used to implement the imaging system 108 of FIG. 1. The imaging system 900 is similar to the imaging system 800 of FIG. 8. The imaging system 900 of FIG. 9, however, includes the laser speckle reducer 802 coupled to the second stage 154 adjacent to the optical receiver 146. As such, the LSR 802 moves with the second stage 154.

FIG. 10 illustrates an isometric top view of another example imaging system 1000 that can be used to implement the imaging system 108 of FIG. 1. The imaging system 1000 is similar to the imaging system 900 of FIG. 8. The imaging system 1000 of FIG. 10, however, includes the optical receiver 146 coupled to the y-stage 136 and a first directional optical element 1002 and a second directional optical element 1004. The directional optical elements 1002 and 1004 direct the laser beam 704 to the optical receiver 146. While two directional optical elements 1002 and 1004 are shown in FIG. 10, any number of directional optical elements may be included (e.g., 1, 3, 4). The first directional optical element 1002 is coupled to the second stage 154 and the second directional optical element 1004 is coupled to the y-stage 136. The first directional optical element 1002 is specifically coupled to the sliding block 610 of the second stage 154 and the second directional optical element 1004 is coupled to the block 344 of the y-stage 136.

The second stage 154 and the y-stage 136 can move together along the second axis 328. The first directional optical element 1002 can thus direct the laser beam 704 to the second directional optical element 1004 because the x-stage 134 and the second stage 154 move together. The movement of the stage assembly 109 and/or the second stage 154 may not impart bending stresses onto the waveguide 140 and/or substantially change a shape of the waveguide 140.

The light source assembly 138 emits the beam 704 in operation that is directed toward the first directional optical element 1002 and the first direction optical element 1002 redirects the beam 704 towards the second directional optical element 1004. The second directional optical element 1004 in turn redirects the beam 704 to the optical receiver 146. The directional optical elements 1002 and/or 1004 are or include reflective optical elements such as mirrors in some implementations. The directional optical elements 1002 and/or 1004 are or include refractive optical elements such as prisms, lenses, or other similar optical elements in other implementations.

The directional optical elements 1002 and 100 may be capable of rotation by way of an actuator depending on the implementation, so as to more precisely direct the laser beam 704. At least one of the first directional optical element 1002 or the second directional optical element 1004 includes a fast and/or low-displacement actuator in some such implementations. The fast and/or low-displacement actuator can dither an angle of the first and/or second directional optical elements 1002 and 1004 at a frequency that is fast relative to the effective exposure time of the imaging system 108 with an amplitude that is small enough for the beam 704 to still fall within the core of the waveguide 140, for example. For a collimator having focal length of 30 mm and a fiber having core size of 600 um, the change in angle could be approximately 0.5 degrees. The directional optical elements 1002 and 1004 can rotate manually or rotate automatically. The directional optical elements 1002, 1004 can rotate manually using a lever, dial, switch and/or the directional optical elements 1002, 1004 rotate automatically in response to receiving a command via the network cables 350, for example.

The directional optical elements 1002 and 1004 may further fan the beam 704 +/−3° in a first direction and +/−3° in a direction orthogonal to the first direction by a crossed 1FCuLA arrangement or a 1FCuLA arrangement combined with a Powell lens or a diffractive optical element. In some implementations, an actuator moving the directional optical elements 1002 and 1004 can be sized to either generate the entire line used to scan the flow cells if used with no beam shaping elements or to completely fill micro-lenses of a second CuLA in a 1FCuLA arrangement without overfilling.

FIG. 11 illustrates an isometric top view of another example imaging system 1100 that can be used to implement the imaging system 108 of FIG. 1. The imaging system 1100 is similar to the imaging system 1000 of FIG. 10. The imaging system 1100 of FIG. 11, however, includes the second directional optical element 1004 coupled to the housing 132. The housing 132 is shown having a bracket 1101 and the second optical element 1004 is coupled to the bracket 1101. The second optical element 1004 may, however, be carried by the housing 132 and/or the stage assembly 109 in different ways.

The first directional optical element 1002 directs the beam 704 from the light source assembly 138 to the second directional optical element 1004 and the second directional optical element 1004 directs the laser beam 704 into a receiving optical element part of the waveguide port 144 or directly into a waveguide incorporated into the waveguide port 144. The imaging system 1100 thus omits the optical fiber 142 and instead includes an optical connection 1102 between light source 138 and the waveguide port 144.

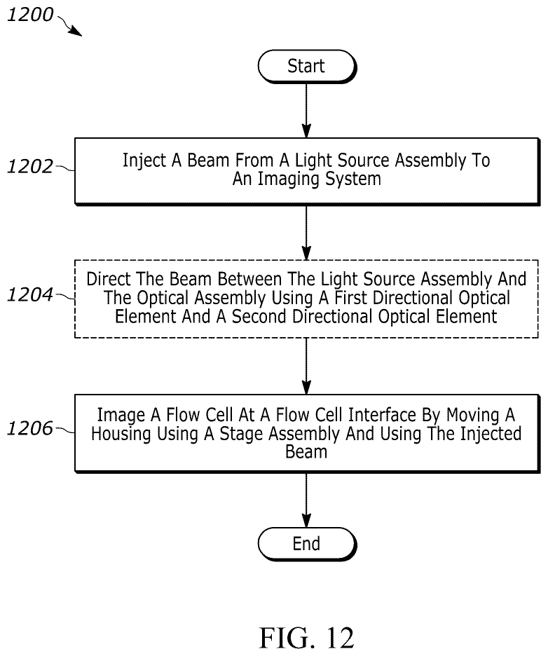

FIG. 12 illustrates a flow chart for a process 1200 of using the system 100 of FIG. 1 and/or any of the imaging systems 108, 300, 400, 500, 600, 700, 800, 900, 1000, 1100 disclosed herein. In the flow chart of FIG. 12, the blocks surrounded by solid lines may be included in an implementation of the process 1200 while the blocks surrounded in dashed lines may be optional in the implementation of the process. Regardless of the way the border of the blocks are presented in FIG. 12, however, the order of execution of the blocks may be changed, and/or some of the blocks described may be changed, eliminated, combined and/or subdivided into multiple blocks.

The process of FIG. 12 beings with the beam 704 being injected from the light source assembly 138 to the imaging system 108 (Block 1202). The imaging system 108 includes the imaging device 128, the optical assembly 130, the housing 132 carrying the imaging device 128 and the optical assembly 130, and the stage assembly 109 coupled to the housing 132.

Injecting the beam 704 includes transmitting the beam 704 from the light source assembly 138 to the imaging system 108 by way of one or more waveguides 140, in some implementations. The one or more waveguides 140 may be one or more optical fibers 142 coupled to the imaging system 108. Injecting the beam 704 may include transmitting the beam 704 from the light source assembly 138 to the imaging system 108 by way of the optical receiver 146 and one or more waveguides 140. The optical receiver 146 can be coupled to the second stage 154. The optical receiver 146 can alternatively be coupled to the stage assembly 109.

The beam 704 is directed between the light source assembly 138 and the optical assembly 130 using the first directional optical element 1002 and the second directional optical element 1004 (Block 1204). Directing the beam 704 between the light source assembly 138 and the optical assembly 130 can include in some implementations directing the beam 704 to the first directional optical element 1002 coupled to the second stage 154, directing the beam 704 from the first directional optical element 1002 to the second directional optical element 1004 coupled to the stage assembly 109, and directing the beam 704 from the second directional optical element 1004 to the optical receiver 146. Directing the beam 704 between the light source assembly 138 and the optical assembly 130 can include in other implementations directing the beam 704 to the first directional optical element 1002 coupled to the second stage 154, directing the beam 704 from the first directional optical element 1002 to the second directional optical element 1004 coupled to the housing 132, and directing the beam 704 from the second directional optical element 1004 to the optical assembly 130.

The flow cell 106 at the flow cell interface 110 is imaged by moving the housing 132 using the stage assembly 109 and using the injected beam 704 (Block 1206). The flow cell 106 is stationary in some implementations. The imaging includes producing a time delay and integration (TDI) image of the flow cell 106 in some implementations. The imaging includes moving the housing 132 along at least one of the first axis 326 by way of the x-stage 134 of the stage assembly 109 or the second axis 328 by way of the y-stage 136 of the stage assembly 109 to image the flow cell 106. The imaging includes moving the light source assembly 138 along at least one of the first axis 326 or the second axis 328 in some implementations when the light source assembly 138 coupled to the y-stage 136. The imaging includes moving the second stage 154 along at least one of the first axis 326 or the second axis 328 in other implementations when the light source assembly 138 is coupled to the second stage 154.

An apparatus, comprising: a system, comprising: a flow cell interface to receive a flow cell cartridge assembly; and an imaging system, comprising: an imaging device; an optical assembly; a housing carrying the imaging device and the optical assembly; a stage assembly coupled to the housing and comprising an x-stage and a y-stage; and a light source assembly to emit a beam that is received by the optical assembly, wherein the stage assembly moves the housing relative to the flow cell interface to allow the imaging device to obtain image data from the flow cell cartridge assembly.

The apparatus of any one or more of the preceding implementations and/or any one or more of the implementations disclosed below, wherein the imaging device is a time delay and integration (TDI) imaging device.

The apparatus of any one or more of the preceding implementations and/or any one or more of the implementations disclosed below, wherein the imaging system comprises a waveguide coupled to the optical assembly.

The apparatus of any one or more of the preceding implementations and/or any one or more of the implementations disclosed below, the waveguide comprises an optical fiber coupled to and between the light source assembly and the optical assembly.

The apparatus of any one or more of the preceding implementations and/or any one or more of the implementations disclosed below, wherein the housing comprises a waveguide port to which the optical fiber is coupled.

The apparatus of any one or more of the preceding implementations and/or any one or more of the implementations disclosed below, wherein the optical fiber is bendable.

The apparatus of any one or more of the preceding implementations and/or any one or more of the implementations disclosed below, wherein the light source assembly is coupled to a portion of the system and the stage assembly is movable relative to the light source assembly.

The apparatus of any one or more of the preceding implementations and/or any one or more of the implementations disclosed below, wherein the portion comprises a frame of the system.

The apparatus of any one or more of the preceding implementations and/or any one or more of the implementations disclosed below, wherein the housing is coupled to the y-stage.

The apparatus of any one or more of the preceding implementations and/or any one or more of the implementations disclosed below, wherein the housing comprises an L-shaped housing having opposing first and second side walls that define an L-shaped channel.

The apparatus of any one or more of the preceding implementations and/or any one or more of the implementations disclosed below, wherein the optical assembly is disposed within the L-shaped channel and the imaging device is coupled to the first and second side walls.

The apparatus of any one or more of the preceding implementations and/or any one or more of the implementations disclosed below, wherein the optical assembly includes a lens group and an entry aperture disposed within the L-shaped channel, and wherein the optical assembly is coupled to the imaging device.

The apparatus of any one or more of the preceding implementations and/or any one or more of the implementations disclosed below, wherein the housing further comprises a waveguide port in the first sidewall or the second sidewall.

The apparatus of any one or more of the preceding implementations and/or any one or more of the implementations disclosed below, further comprising a waveguide, wherein a first end of the waveguide is coupled to the light source assembly and a second end of the waveguide is coupled to the waveguide port.

The apparatus of any one or more of the preceding implementations and/or any one or more of the implementations disclosed below, wherein the light source assembly is movable relative to the waveguide port and the waveguide is bendable in two directions.

The apparatus of any one or more of the preceding implementations and/or any one or more of the implementations disclosed below, wherein the light source assembly is coupled to the y-stage.

The apparatus of any one or more of the preceding implementations and/or any one or more of the implementations disclosed below, further comprising a heat sink coupled to the light source assembly.

The apparatus of any one or more of the preceding implementations and/or any one or more of the implementations disclosed below, further comprising a second stage to which the light source assembly is coupled.

The apparatus of any one or more of the preceding implementations and/or any one or more of the implementations disclosed below, wherein the second stage comprises a follower stage.

The apparatus of any one or more of the preceding implementations and/or any one or more of the implementations disclosed below, wherein the second stage comprises a one-dimensional movement stage.

The apparatus of any one or more of the preceding implementations and/or any one or more of the implementations disclosed below, wherein the light source assembly is coupled to the second stage.

The apparatus of any one or more of the preceding implementations and/or any one or more of the implementations disclosed below, wherein the system causes the second stage to move corresponding to the movement of at least one of the x-stage or the y-stage.

The apparatus of any one or more of the preceding implementations and/or any one or more of the implementations disclosed below, wherein the second stage comprises at least one of an x-stage or a y-stage.

The apparatus of any one or more of the preceding implementations and/or any one or more of the implementations disclosed below, further comprising a waveguide and an optical receiver to receive the beam, the waveguide coupled to and between the optical receiver and the optical assembly.

The apparatus of any one or more of the preceding implementations and/or any one or more of the implementations disclosed below, wherein the optical receiver comprises a fiber coupling lens.

The apparatus of any one or more of the preceding implementations and/or any one or more of the implementations disclosed below, further comprising a second stage to which the optical receiver is coupled.

The apparatus of any one or more of the preceding implementations and/or any one or more of the implementations disclosed below, wherein the optical receiver includes one or more of: (i) a collimator, (ii) a microlens array, (iii) a diffractive optical element, (iv) a Powell lens, (v) a Lineman lens, (vi) a cylindrical lens, or (vii) an acylindrical lens.

The apparatus of any one or more of the preceding implementations and/or any one or more of the implementations disclosed below, wherein the system causes the second stage to move the optical receiver relative to the light source assembly.

The apparatus of any one or more of the preceding implementations and/or any one or more of the implementations disclosed below, further comprising a laser speckle reducer disposed perpendicular to the beam.

The apparatus of any one or more of the preceding implementations and/or any one or more of the implementations disclosed below, further comprising a laser speckle reducer coupled adjacent to the light source assembly.

The apparatus of any one or more of the preceding implementations and/or any one or more of the implementations disclosed below, further comprising a laser speckle reducer coupled to the second stage adjacent to the optical receiver.

The apparatus of any one or more of the preceding implementations and/or any one or more of the implementations disclosed below, wherein the optical receiver is coupled to the y-stage.

The apparatus of any one or more of the preceding implementations and/or any one or more of the implementations disclosed below, further comprising a first directional optical element and a second directional optical element.

The apparatus of any one or more of the preceding implementations and/or any one or more of the implementations disclosed below, further comprising a second stage and wherein the first directional optical element is coupled to the second stage and the second directional optical element is coupled to the y-stage.

The apparatus of any one or more of the preceding implementations and/or any one or more of the implementations disclosed below, wherein the light source assembly directs the beam to the first directional optical element, the first directional optical element redirects the beam to the second directional optical element, and the second directional optical element redirects the beam to the optical receiver.

The apparatus of any one or more of the preceding implementations and/or any one or more of the implementations disclosed below, wherein at least one of the first directional optical element or the second directional optical element includes a low-displacement actuator.

The apparatus of any one or more of the preceding implementations and/or any one or more of the implementations disclosed below, wherein the first directional optical element is coupled to the second stage and the second directional optical element is coupled to the housing.

The apparatus of any one or more of the preceding implementations and/or any one or more of the implementations disclosed below, wherein the light source assembly is a laser diode illuminator (LDI).

A method, comprising: injecting a beam from a light source assembly to an imaging system, the imaging system comprising an imaging device, an optical assembly, a housing carrying the imaging device and the optical assembly, and a stage assembly coupled to the housing; and imaging a flow cell at a flow cell interface by moving the housing using the stage assembly and using the injected beam.

The method of any one or more of the preceding implementations and/or any one or more of the implementations disclosed below, wherein the imaging includes producing a time delay and integration (TDI) image of the flow cell.

The method of any one or more of the preceding implementations and/or any one or more of the implementations disclosed below, wherein injecting the beam includes transmitting the beam from the light source assembly to the imaging system by way of one or more waveguides.

The method of any one or more of the preceding implementations and/or any one or more of the implementations disclosed below, wherein the one or more waveguides are one or more optical fibers coupled to the imaging system.

The method of any one or more of the preceding implementations and/or any one or more of the implementations disclosed below, wherein the flow cell is stationary.

The method of any one or more of the preceding implementations and/or any one or more of the implementations disclosed below, wherein the imaging includes moving the housing along at least one of a first axis by way of an x-stage of the stage assembly or a second axis by way of a y-stage of the stage assembly to image the flow cell.

The method of any one or more of the preceding implementations and/or any one or more of the implementations disclosed below, wherein the imaging includes moving the light source assembly along at least one of the first axis or the second axis, wherein the light source assembly is coupled to the y-stage.

The method of any one or more of the preceding implementations and/or any one or more of the implementations disclosed below, wherein the imaging further includes moving a second stage along at least one of the first axis or the second axis, wherein the light source assembly is coupled to the second stage.

The method of any one or more of the preceding implementations and/or any one or more of the implementations disclosed below, wherein injecting the beam includes transmitting the beam from the light source assembly to the imaging system by way of an optical receiver and one or more waveguides.

The method of any one or more of the preceding implementations and/or any one or more of the implementations disclosed below, wherein the optical receiver is coupled to a second stage.

The method of any one or more of the preceding implementations and/or any one or more of the implementations disclosed below, further comprising directing the beam between the light source assembly and the optical assembly using a first directional optical element and a second directional optical element.

The method of any one or more of the preceding implementations and/or any one or more of the implementations disclosed below, wherein directing the beam between the light source assembly and the optical assembly using the first directional optical element and the second directional optical element, comprises: directing the beam to the first directional optical element coupled to a second stage; directing the beam from the first directional optical element to the second directional optical element coupled to the stage assembly; and directing the beam from the second directional optical element to an optical receiver.

The method of any one or more of the preceding implementations and/or any one or more of the implementations disclosed below, wherein directing the beam between the light source assembly and the optical assembly using the first directional optical element and the second directional optical element, comprises: directing the beam to the first directional optical element coupled to a second stage; directing the beam from the first directional optical element to the second directional optical element coupled to the housing; and directing the beam from the second directional optical element to the optical assembly.

An apparatus, comprising: a system, comprising: a flow cell interface to receive a flow cell cartridge assembly; and an imaging system, comprising: an imaging device; an optical assembly; a housing carrying the imaging device and the optical assembly; a stage assembly coupled to the housing; and a light source assembly to emit a beam that is received by the optical assembly, wherein the stage assembly moves the housing relative to the flow cell interface to allow the imaging device to obtain image data from the flow cell cartridge assembly.

The apparatus of any one or more of the preceding implementations and/or any one or more of the implementations disclosed below, wherein the stage assembly comprises a stage.

The apparatus of any one or more of the preceding implementations and/or any one or more of the implementations disclosed below, wherein the stage comprises an x-stage.

The apparatus of any one or more of the preceding implementations and/or any one or more of the implementations disclosed below, wherein the stage comprises a y-stage.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a system, comprising:
a flow cell interface to receive a flow cell cartridge assembly; and
an imaging system, comprising:
an imaging device;
an optical assembly;
a housing carrying the imaging device and the optical assembly;
a stage assembly coupled to the housing and comprising an x-stage and a y-stage; and
a light source assembly to emit a beam that is received by the optical assembly,
wherein the stage assembly moves the housing relative to the flow cell interface to allow the imaging device to obtain image data from the flow cell cartridge assembly.

2. The apparatus of claim 1, wherein the imaging device is a time delay and integration (TDI) imaging device.

3. The apparatus of claim 1, wherein the imaging system comprises a waveguide coupled to the optical assembly, wherein the waveguide comprises an optical fiber coupled to and between the light source assembly and the optical assembly, wherein the housing comprises a waveguide port to which the optical fiber is coupled.

4-6. (canceled)

7. The apparatus of claim 1, wherein the light source assembly is coupled to a portion of the system and the stage assembly is movable relative to the light source assembly, wherein the portion comprises a frame of the system.

8-9. (canceled)

10. The apparatus of claim 1, wherein the housing comprises an L-shaped housing having opposing first and second side walls that define an L-shaped channel, wherein the optical assembly is disposed within the L-shaped channel and the imaging device is coupled to the first and second side walls, wherein the optical assembly includes a lens group and an entry aperture disposed within the L-shaped channel, and wherein the optical assembly is coupled to the imaging device.

11-12. (canceled)

13. The apparatus of claim 10, wherein the housing further comprises a waveguide port in the first sidewall or the second sidewall, further comprising a waveguide, wherein a first end of the waveguide is coupled to the light source assembly and a second end of the waveguide is coupled to the waveguide port, wherein the light source assembly is movable relative to the waveguide port and the waveguide is bendable in two directions.

14-15. (canceled)

16. The apparatus of claim 1, wherein the light source assembly is coupled to the y-stage, further comprising a heat sink coupled to the light source assembly.

17. (canceled)

18. The apparatus of claim 1, further comprising a second stage to which the light source assembly is coupled.

19. The apparatus of claim 18, wherein the second stage comprises a follower stage.

20. The apparatus of claim 18, wherein the second stage comprises a one-dimensional movement stage.

21. The apparatus of claim 18, wherein the light source assembly is coupled to the second stage.

22. The apparatus of claim 18, wherein the system causes the second stage to move corresponding to the movement of at least one of the x-stage or the y-stage.

23. (canceled)

24. The apparatus of claim 1, further comprising a waveguide and an optical receiver to receive the beam, the waveguide coupled to and between the optical receiver and the optical assembly.

25. The apparatus of claim 24, wherein the optical receiver comprises a fiber coupling lens.

26. The apparatus of claim 24, further comprising a second stage to which the optical receiver is coupled.

27. The apparatus of claim 24, wherein the optical receiver includes one or more of: (i) a collimator, (ii) a microlens array, (iii) a diffractive optical element, (iv) a Powell lens, (v) a Lineman lens, (vi) a cylindrical lens, or (vii) an acylindrical lens.

28-51. (canceled)

52. An apparatus, comprising:
a system, comprising:
a flow cell interface to receive a flow cell cartridge assembly; and
an imaging system, comprising:
an imaging device;
an optical assembly;
a housing carrying the imaging device and the optical assembly;
a stage assembly coupled to the housing; and
a light source assembly to emit a beam that is received by the optical assembly,
wherein the stage assembly moves the housing relative to the flow cell interface to allow the imaging device to obtain image data from the flow cell cartridge assembly.

53. The apparatus of claim 52, wherein the stage assembly comprises a stage.

54. The apparatus of claim 53, wherein the stage comprises an x-stage.

55. The apparatus of claim 53, wherein the stage comprises a y-stage.
